(19) United States
(12) Patent Application Publication
(10) Pub. No.: US 2008/0157982 A1
(43) Pub. Date: Jul. 3, 2008

(54) LED signaling electronic rodent repeller

(75) Inventors: Isaac Weiser, Tarzana, CA (US); Margaret Weiser, Tarzana, CA (US); Albert M. Williams, Sylmar, CA (US)

Correspondence Address: Cislo & Thomas LLP, 1333 2nd Street, Suite #500, Santa Monica, CA, 90401-4110, US

(73) Assignee: Exhart Environmental Systems, Inc.

(21) Appl. No.: 11/649,385

(22) Filed: Jan. 3, 2007

(51) Int. Cl. G08B 21/00; G08B 23/00

(52) U.S. Cl. 340/573.2; 340/636.15

(57) ABSTRACT

A rodent repeller having an elongated body, an end cap, an apex, a power supply, a buzzer, an LED, an LED transformer, and a buzzer transformer. Connection of the power supply to the buzzer via the buzzer transformer produces a signal to discourage rodents from remaining in a vicinity of the repeller stake, and connection of the power supply to the LED via the LED transformer produces a visual indicator that the repeller stake is operable. The LED transformer receives a voltage from the power supply, and the voltage varies in amount from a high voltage to a low voltage. The LED transformer controls the amount of power to the LED such that the LED has a high brightness when the high voltage is received by the LED transformer and the LED has a low brightness when the low voltage is received by the LED transformer.

### TECHNICAL FIELD

This invention relates to electronic devices to non-lethally repel rodents, and more specifically to devices that repel rodents by use of sound or vibration.

### BACKGROUND ART

Gardeners are well aware of the damage to plants, flowerbeds, gardens, and lawns that rodents such as moles, voles, and mice can cause. Because of this damage, many people seek to keep rodents away from their gardens and lawns and to be rid of those that are already there. However, people often do not want to trap the animals because of the complexity of positioning a trap, baiting it, checking the trap, removing any caught animals, and then resetting the trap. Traps may also pose a danger to persons or non-pest animals. Furthermore, traps that kill the animal are often considered inhumane, gruesome, or otherwise inappropriate solutions to the problem.

One way to combat this problem is by way of rodent deterrent stakes. These devices are generally driven into the ground where they emit sound, ultrasonic frequencies, vibrate, or some combination of those to discourage rodents from occupying the region near the stake or array of such stakes. However, these rodent deterrent stakes often resulted in devices with unsatisfactory battery life, decreased sound output as battery power is expended, or no readily discernible way to determine whether the device is operating once it is installed in the ground.

Therefore, there exists a need for a non-lethal device to repel rodents from gardens, lawns, and the like. There also is a need for the device to be easily installed, easily maintained, and self-contained. There further exists a need that the device provides a visual cue to the user that it is operating.

### DISCLOSURE OF INVENTION

The rodent repeller of the present invention may have an elongated body, an end cap, an apex, a power supply, a buzzer, an LED, an LED transformer, and a buzzer transformer. The LED transformer controls the amount of power to the LED, and the buzzer transformer to control power to the buzzer. Connection of the power supply to the buzzer via the buzzer transformer produces a signal to discourage rodents from remaining in the vicinity of the repeller stake, and connection of the power supply to the LED via the LED transformer produces a visual indicator that the repeller stake is operable.

The LED has a high brightness and a low brightness, the low brightness being dimmer than the high brightness. The LED transformer receives a voltage from the power supply, and the voltage varies in amount from a high voltage to a low voltage. The LED transformer controls the amount of power to the LED such that the LED has a high brightness when the high voltage is received by the LED transformer and the LED has a low brightness when the low voltage is received by the LED transformer. Thus a visual indicator of the relative power remaining in the power supply is provided. In some embodiments, an unlit LED may indicate that the buzzer is not operating, regardless of the amount of relative power in the power supply.

### BRIEF DESCRIPTION OF DRAWINGS

FIG. 1 is a perspective view of an embodiment of an LED signaling electronic rodent repeller.

FIG. 2 is a side view of a partially exploded, partially cut away embodiment of an LED signaling electronic rodent repeller.

FIG. 3 is a cutaway view of the handle of an embodiment of an LED signaling electronic rodent repeller.

FIG. 4 is a top view of the handle of an embodiment of an LED signaling electronic rodent repeller.

FIG. 5 is a depiction of an electrical circuit of an embodiment of an LED signaling electronic rodent repeller.

FIG. 6 is an electrical schematic of an embodiment of an LED signaling electronic rodent repeller.

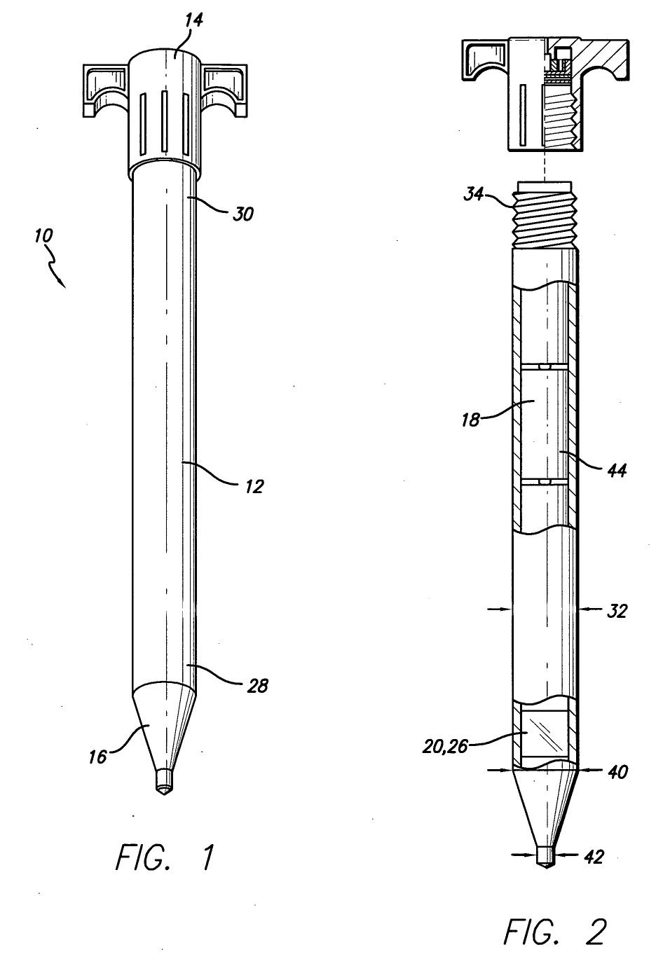

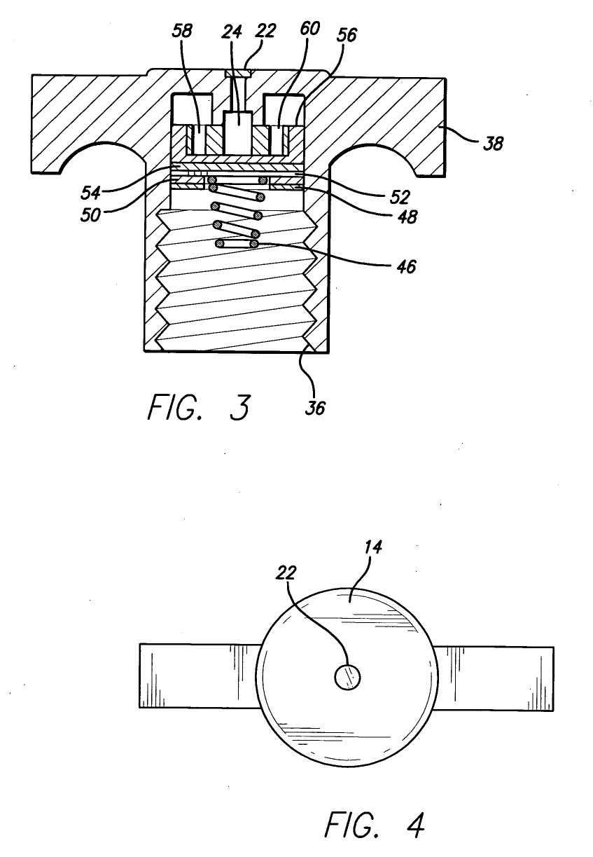

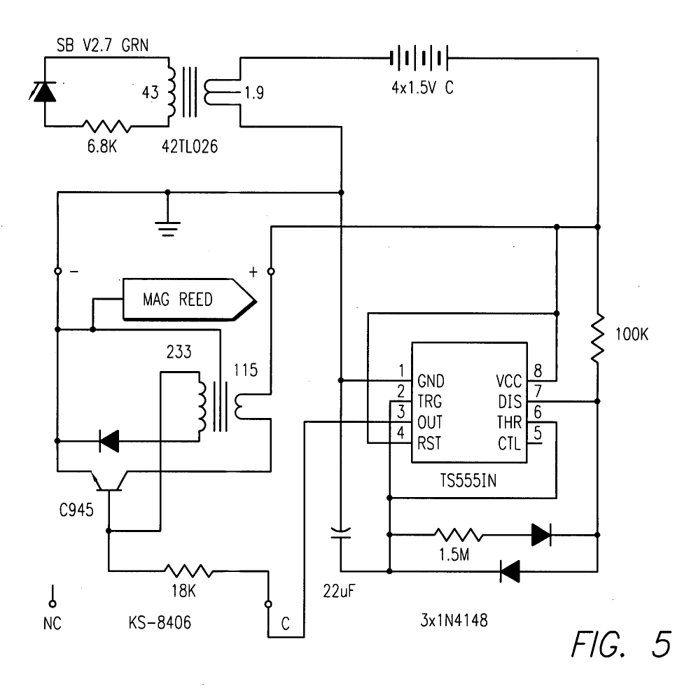

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Referring to the Figures, the present invention is directed to an electronic rodent repeller 10 for insertion into the ground. The rodent repeller 10 has an elongated body 12, an end cap 14, an apex 16, a power supply 18, a buzzer 20, an LED 22, and electronic controller 36.

The elongated body 12 has an inserted end 28, a upper end 30, and an outside diameter 32. The upper end 30 may have threads 34. The elongated body 12 is preferably a cylinder or tube, although elongated bodies having a triangular, square, or other polygonal cross-sections are also contemplated.

The end cap 14 may have threads 36 to mate with the threads 34. The end cap 14 may be threaded to the upper end 30 of the elongated body 12, although it is also contemplated that the end cap 14 be connected to the elongated body 12 by other approaches, such as gluing, welding, interference fit, and other techniques. In some embodiments, the end cap 14 may be a T-bar or T-handle, such that the end cap 14 has two protrusions 38 that emerge perpendicular to the main part of the end cap 14. The protrusions 38 facilitate installation and removal of the end cap 14 from the elongated body 12. The protrusions 38, which may be a jut, projection, or nub, also provide a handle for the user when pulling the electronic rodent repeller 10 from the ground. It is also contemplated that there may be zero, one, or more than two protrusions 38.

The apex 16 is connected to the inserted end 28 of the elongated body 12. The apex 16 may be a cone or pyramid, and it generally defines a pointed or blunted tip for the electronic rodent repeller 10. For embodiments having an elongated body 12 that is cylindrical, the apex 16 is preferably a cone, where the base diameter 40 of the cone is generally equivalent to the outside diameter 32 of the elongated body 12. An apex 16 that is conical further has a second diameter 42 that is smaller than the first diameter 26, such that the cone tapers from the first diameter 26 to the second diameter 42 to permit insertion of the rodent repeller 10 into the ground. For embodiments having an elongated body 12 that has a polygonal cross-section, the apex 16 is preferably a pyramid whose base generally matches the polygonal cross-section of the elongated body 12, such that there is a generally continuous transition between the elongated body 12 and the apex 16. For both the conical or pyramidal apex 16, the apex 16 may taper to a sharp point or to a blunt tip.

The power supply 18 may include one or more batteries 44. Preferably, the power supply 18 has four “C” cell batteries.

The electronic controller 36 connects the LED 22, the power supply 18, and the buzzer 20. The electronic controller 36 includes an LED transformer 24, and a buzzer transformer 26.

The LED transformer 24 may be a Xicon® 42TL026 transformer, which is commercially available from Mouser Electronics, Inc.,. 1000 North Main Street, North Mansfield, Tex. 76063. Preferably, the LED transformer 24 is a Pico Electronics type 81165 transformer, which is commercially available from Pico Electronics USA, 7920 Tapia Street, Fontana, Calif. 92336. The Pico transformer is preferred, in part, because its volume is about one-third that of the Xicon® transformer. However, it is equally contemplated that other transformers may be utilized in the electronic rodent repeller 10.

The buzzer transformer 26 controls power to the buzzer 20. The buzzer transformer 26 may be located within the end cap 14, or it may be located immediately adjacent the buzzer 20. In some embodiments, the buzzer transformer 26 may be integral to the buzzer 20, for example, when the buzzer 20 is the purchased subassembly type KS-8406 referred to below.

The LED transformer 24 controls the amount of current received by the LED 22 to provide a visual indication of relative electric potential of the power supply 18 or the operability of the buzzer 20. Preferably, there is a 3:1 ratio between the brightness of the LED 22 at generally full power (e.g. fresh batteries producing about 6 volts) and the brightness of the LED 22 at minimum usable power (e.g. partially used batteries producing about 2.5 volts). The LED brightness is given by the equation B=10exp{[10exp(−4/3)][10 log₁₀(I2/I1)]}, where I1 is the measured illuminance at low voltage (e.g. 2.5 volts) and I2 is the measured illuminance at high voltage (e.g. 6 volts).

In embodiments of the invention having a resonant reed sounder, light may be emitted by the LED 22 as a result of polarized pulses of current that pass through the LED transformer 24 and into the LED 22 at the frequency of the resonator. This frequency is generally about ten times greater than the flutter detection frequency of the human visual system. As such, a constant, uniform intensity is generally perceived by a human observer. If the resonator is modulated at a frequency within about ten percent of the self-resonant frequency or at a frequency below about one-tenth self-resonant frequency, that modulation will generally appear as bursts of light or pulsating (integrated) light.

The LED 22 thus provides a visual signal to the user of the condition of the power supply 18. When the LED 22 is relatively bright, the supplied power is relatively high, and when the LED 22 is relatively dim, the supplied power is relatively low. When the LED brightness is between the relatively high and relatively dim levels, an intermediate amount of supplied power is indicated. When the LED 22 is not lit, the power supply is generally below a useable level such that the buzzer 20 may not be operating at a level sufficient to repel rodents. When the power level is relatively low, the user may want to renew the power supply by, for example, replacing any batteries. Using a light meter to test an embodiment of the invention, the inventors noted an actual illuminance of about 73 lux at a battery voltage of about 2.5 volts and an actual illuminance of about 565 lux at a battery voltage of about 6.0 volts. These values resulted in a brightness range of about 2.6:1 over the battery range from 2.5 volts to 6.0 volts. In some embodiments, an unlit LED 22 may also indicate that the buzzer 20 is not functioning for a reason other than a low power supply, such as a short circuit, open circuit, or other failure of the buzzer 20. In such embodiments, a lit LED 22 may also indicate that the buzzer 20 is properly functioning.

The buzzer 20, which may be a noisemaker, chime, or vibrator, is generally located at the inserted end 28 of the elongated body 12. This position allows the buzzer 20, when the electronic rodent repeller 10 is installed in the ground, to be at an appropriate depth beneath the surface of the ground to permit the sound or vibration produced by the repeller 10 to travel through the ground. The buzzer 20 may be any device that produces an audible or vibratory signal perceivable by rodents. Preferably, the buzzer 20 is a resonant reed sounder, such as a type KS-8406 or a type KS-3603. A resonant reed sounder, also known as a Helmholtz resonator, is preferred since it helps bring about the battery longevity discussed below.

The LED 22 may be a standard light emitting diode and it may be a super bright LED. The LED 22 is preferably a 3 mm green LED, such as a model number RL5-B2545. However, the LED 22 may emit light of various colors such as white, green, red, blue, amber, and others. It is also contemplated that other small light bulbs or other light sources may be used with the device.

The LED transformer 24 and LED 22 are preferably located within the end cap 14. This placement allows for ease of access, maintenance, or retrofit of similar units where desired. The end cap 14 may further contain a battery spring 46, a contact ring 48, a fiber insulator 50, a spring plate 52, and a neoprene washer 54. A ground circuit pin 58 is connected to the contact ring 48, and a negative battery pin 60 is connected to the battery spring 46 via the spring plate 52. The connections may be by welding, soldering, or otherwise attaching the pin to its respective connecting structure. Along with a fastener, such as a screw, through the spring plate 52 and extending into the end cap 14, there may be push-on clips on the ground circuit pin 58 and the negative battery pin 60 to further secure the assembly to the end cap 14.

In the depicted embodiment, the battery spring 46 extends through a space in the center of the contact ring 48 to connect to the spring plate 52. The contact ring 48 and the spring plate 52 are separated by the fiber insulator 50. The neoprene washer 54 separates the spring plate 52 from the plug 56. The plug 56 may be an acrylonitrile-butadiene-styrene (ABS) insulator. The spring plate 52, contact ring 48, fiber insulator 50, and neoprene washer 54 may be permanently bonded together for ease of installation or retrofit of similar rodent repeller devices.

In the preferred embodiment, the rodent repeller 10 is activated by twisting the end cap 14 about the elongated body 12 in a direction corresponding to tightening the end cap 14 onto the elongated body 12. When the end cap 14 is twisted such that the contact ring 48 contacts the elongated body 12 and the battery spring 46 contacts the negative terminal of the power supply 18, an electric circuit is completed between the power supply 18, the buzzer 20, and the LED 22. Activation by other techniques, such as by push button, toggle switch, or sliding the end cap, are also contemplated. Once activated, some versions may be sealed against the weather or to prevent tampering. The connection of the power supply 18 to the buzzer 20 produces an audible or vibratory signal to discourage rodents from remaining in the vicinity of the rodent repeller 10. Furthermore, connection of the power supply to the LED 22 produces a visual indicator that the rodent repeller 10 is operable.

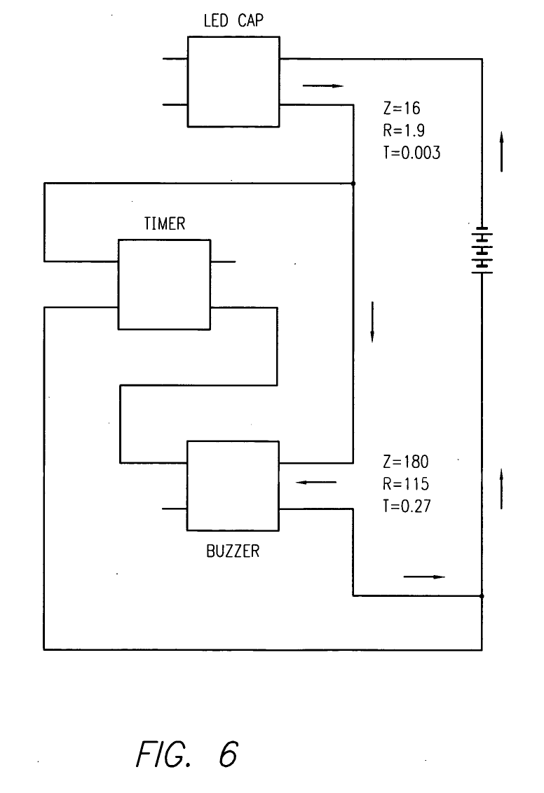

FIG. 6 highlights the ground connections between the LED 22 and the buzzer 20. The arrows in the figure show the current loop through the power supply 18, in this case a battery. As depicted, the LED 22 may have a time constant of T=0.003 seconds, an impedance of Z=16 ohms, and a resistance of R=1.9 ohms. The buzzer 20 may have a time constant of T=0.27 seconds, an impedance of Z=180 ohms, and a resistance of R=115 ohms. Each time constant is related to the parameters of the transformer windings in the respective device. Preferably, the ratio of these parameters favors the buzzer, as better performance is achieved when that is so. In the example, each ratio clearly does favor the buzzer: 0.27/0.003≧90; 180/16 ≧11; and 115/1.9≧60.

Along with ease of use and providing a visual indication that the device is operating, another advantage of the invention is increased battery life. By reducing the drive current to the buzzer or resonant reed sounder, the inventors were able to improve battery longevity by about 8%, while only having about a ½ dB reduction in sound pressure level. For example, the standard buzzer input power is about 25 mW at about 4.25 volts DC. A reduction in buzzer input power to about 21.1 mW at 4.25 volts DC (from a reduction in current of about 8.8%) produced a reduction in loudness of about 0.6 dB. Since a change in sound pressure level of less than 1 dB is generally considered to be below the perception threshold, a 0.6 dB reduction is inaudible.

While the present invention has been described in regard to particular embodiments, it is recognized that additional variations of the present invention may be devised without departing from the inventive concept.

### INDUSTRIAL APPLICABILITY

This invention may be industrially applied to electronic devices that non-lethally repel rodents by use of sound and vibration

What is claimed is:

1. A rodent repeller for insertion into the ground, comprising:
(a) an elongated body having an inserted end, an upper end, and an outside diameter, the upper end having threads, the elongated body being a cylinder;
(b) an end cap threaded to the upper end of the elongated body, the end cap comprising a T-handle, the T-handle having two protrusions that emerge perpendicular to a main part of the end cap;
(c) an apex at the inserted end of the elongated body, the apex being a cone having a base diameter generally equivalent to the outside diameter of the elongated body, the apex having a second diameter that is smaller than the base diameter such that the apex tapers from the base diameter to the second diameter;
(d) a power supply, the power supply comprising at least one battery;
(e) a buzzer, the buzzer being a resonant reed sounder;
(f) an LED, the LED having a brightness;
(g) an LED transformer, the LED transformer controlling an amount of power to the LED such that there is a generally 3:1 ratio between the brightness of the LED at an amount of power of about 6 volts and the brightness of the LED at an amount of power of about 2.5 volts; and
(h) a buzzer transformer to control power to the buzzer;
wherein connection of the power supply to the buzzer, via the buzzer transformer, produces an audible signal to discourage rodents from remaining in a vicinity of the repeller stake; and
wherein connection of the power supply to the LED, via the LED transformer, produces a relative visual indicator, by brightness, that the repeller stake is operable.

2. An electronic rodent repeller, comprising:
(a) an elongated body having an inserted end, an upper end, and an outside perimeter;
(b) an end cap connected to the upper end of the elongated body;
(c) an apex at the inserted end of the elongated body;
(d) a power supply located within the elongated body;
(e) a buzzer located within the elongated body;
(f) an LED connected to the end cap;
(g) an LED transformer, the LED transformer controlling an amount of power to the LED; and
(h) a buzzer transformer controlling power to the buzzer;
wherein connection of the power supply to the buzzer, via the buzzer transformer, produces a signal to discourage rodents from remaining in a vicinity of the repeller stake; and
wherein connection of the power supply to the LED, via the LED transformer, produces a visual indicator that the repeller stake is operable.

3. The electronic rodent repeller of claim 2, the end cap further comprising at least one nub that protrudes generally perpendicularly from the end cap.

4. The electronic rodent repeller of claim 3, the at least one nub being two oppositely spaced nubs.

5. The electronic rodent repeller of claim 2, the elongated body being a cylinder and the outside perimeter being an outside diameter.

6. The electronic rodent repeller of claim 5, the apex being a cone having a base diameter generally equivalent to the outside diameter of the elongated body.

7. The electronic rodent repeller of claim 2, the elongated body having a polygonal cross-section.

8. The electronic rodent repeller of claim 7, the apex being a pyramid having a base dimension that generally matches the polygonal cross-section of the elongated body.

9. The electronic rodent repeller of claim 2, the power supply comprising at least one battery.

10. The electronic rodent repeller of claim 2, the buzzer being a resonant reed sounder.

11. The electronic rodent repeller of claim 2, the LED having a high brightness and a low brightness, the low brightness being more dim than the high brightness, the LED transformer receiving a voltage from the power supply, the voltage varying in amount from a high voltage to a low voltage, the LED transformer controlling the amount of power to the LED such that the LED has a high brightness when the high voltage is received by the LED transformer and the LED has a low brightness when the low voltage is received by the LED transformer.

12. The electronic rodent repeller of claim 11, the LED further having an intermediate brightness being more dim than the high brightness and less dim than the low brightness, the LED transformer further receiving an intermediate voltage from the power supply, the intermediate voltage being between the high voltage and the low voltage, the LED transformer controlling the amount of power to the LED such that the LED has an intermediate brightness when the intermediate voltage is received by the LED transformer.

13. An electronic noise generator, comprising:
(a) a tube having a upper end and a lower end;
(b) an end plug connected to the upper end of the tube;
(c) a projecting tip at the lower end of the tube;
(d) an electric power supply inside the tube;
(e) a chime inside the tube;
(f) an indicator light connected to the end plug; and
(g) an electronic transformer;
wherein connection of the electric power supply to the chime produces a signal to discourage rodents from remaining in a vicinity of the electronic noise generator; and
wherein connection of the electric power supply to the indicator light produces a visual indication that the electronic noise generator is operable.

14. The electronic noise generator of claim 13, the chime being a resonant reed sounder.

15. The electronic noise generator of claim 13, the indicator light having a high brightness and a low brightness, the low brightness being more dim than the high brightness, the electronic transformer receiving a voltage from the electric power supply, the voltage varying in amount from a high voltage to a low voltage, the electronic transformer controlling the amount of power to the indicator light such that the indicator light has a high brightness when the high voltage is received by the electronic transformer and the indicator light has a low brightness when the low voltage is received by the electronic transformer.

16. A visual indicator for a battery power supply, comprising:
(a) a light indicator, the light indicator having a high brightness and a low brightness, the low brightness being more dim than the high brightness;
(b) a battery power supply; and
(c) an electronic transformer, the electronic transformer receiving a voltage from the battery power supply, the voltage varying in amount from a high voltage to a low voltage;
wherein connection of the battery electric power supply to the light indicator, via the electronic transformer, produces a visual indication of the relative power supplied by the battery power supply, the visual indication comprising the electronic transformer controlling the amount of power to the light indicator such that the light indicator has a high brightness when the high voltage is received by the electronic transformer and the light indicator has a low brightness when the low voltage is received by the electronic transformer.

17. A method of repelling rodents, comprising the steps of:
(a) providing an electronic rodent repeller having
1. an elongated body having an inserted end and an upper end;
2. a power supply located within the elongated body, the power supply having a decaying amount of electric potential;
3. a light source located at the upper end of the elongated body, the light source having a high brightness and a low brightness, the low brightness being more dim than the high brightness;
4. an electronic transformer within the elongated body, the electronic transformer receiving a voltage from the power supply, the voltage varying in amount from a high voltage to a low voltage; and
5. a buzzer located within the elongated body;
(b) inserting the electronic rodent repeller, inserted end first, into the ground, such that the light source remains visible above the ground;
(c) activating the electronic rodent repeller such that the buzzer emits an audible sound; and
(d) providing an indication of power supplied to the buzzer by illuminating the light source, the illuminated light source indicating that the power supply has electric potential, the visual indication comprising the electronic transformer controlling the amount of power to the light source such that the light source has a high brightness when the high voltage is received by the electronic transformer and the light source has a low brightness when the low voltage is received by the electronic transformer, the low brightness being more dim than the high brightness.

18. The method of claim 17, the provided light source being a light emitting diode.

19. A method of providing a relative visual indication of battery power level, comprising the steps of:
(a) providing:
1. a light indicator, the light indicator having a high brightness and a low brightness, the low brightness being more dim than the high brightness;
2. a battery power supply; and
3. an electronic transformer, the electronic transformer receiving a voltage from the battery power supply, the voltage varying in amount from a high voltage to a low voltage; and
(b) providing a visual cue, the visual cue comprising the electronic transformer controlling the amount of power to the light indicator such that the light indicator has a high brightness when the high voltage is received by the electronic transformer and the light indicator has a low brightness when the low voltage is received by the electronic transformer.

20. The method of claim 19, the light indicator further having an intermediate brightness being more dim than the high brightness and less dim than the low brightness, the electronic transformer further receiving an intermediate voltage from the power supply, the intermediate voltage being between the high voltage and the low voltage, and the visual cue further including the electronic transformer controlling the amount of power to the light indicator such that the light indicator has an intermediate brightness when the intermediate voltage is received by the electronic transformer.
